(19) United States
(12) Patent Application Publication
(10) Pub. No.: US 2025/0171329 A1
(43) Pub. Date: May 29, 2025

(54) LITHIUM-CHROMIUM-IRON DISORDERED ROCK-SALT BATTERY CATHODE MATERIALS AND SYNTHESES THEREOF

(71) Applicant: Toyota Research Institute, Inc., Los Altos, CA (US)

(72) Inventors: Steven Bartholomew Joseph Torrisi, Berkeley, CA (US); Christopher Wolverton, Wilmette, IL (US); Yizhou Zhu, Hangzhou (CN); Tzu-Chen Liu, Evanston, IL (US); Bianca Baldassarri, Jagna (PH); Adolfo Salgado-Casanova, Chicago, IL (US); Muratahan Aykol, San Jose, CA (US); So Yubuchi, Sunto-gun (JP); Hisatsugu Yamasaki, Gotemba-shi (JP); Jun Yoshida, Mishima-shi (JP)

(73) Assignees: Toyota Research Institute, Inc., Los Altos, CA (US); Toyota Jidosha Kabushiki Kaisha, Toyota-shi Aichi-ken (JP); Northwestern University, Evanston, IL (US)

(21) Appl. No.: 18/897,588

(22) Filed: Sep. 26, 2024

Related U.S. Application Data
(60) Provisional application No. 63/603,828, filed on Nov. 29, 2023.

(51) Int. Cl. C01G 49/00; H01M 10/0525

(52) U.S. Cl. CPC C01G 49/0018; H01M 10/0525; C01P 2002/74; C01P 2002/77; C01P 2006/40

(57) ABSTRACT

A cathode for a battery includes a cathode material with the chemical formula Li_{1+δ}FeₓCr_{y}O₂ where 0≤δ≤1, and δ+x+y=2. In some variations, the cathode material has a disordered rock-salt crystal structure and the chemical formula Li_{1+δ}FeₓCr_{y}O₂ where 0≤δ≤1, and δ+x+y=2. And in at least one variations, a method of forming the cathode material includes wet ball milling solid precursors of lithium, iron, and chromium and forming a slurry, drying the slurry and forming a powder, sintering the powder, and dry ball milling the powder and forming the cathode material with the disordered rock-salt crystal structure and the chemical formula Li_{1+δ}FeₓCr_{y}O₂ where 0≤δ≤1, and δ+x+y=2.

### CROSS-REFERENCE TO RELATED APPLICATIONS

This application claims the benefit of U.S. Provisional Application No. 63/603,828, filed Nov. 19, 2023, which is incorporated herein in its entirety by reference.

### TECHNICAL FIELD

The present disclosure relates generally to battery cathode materials and particularly to battery cathode materials with a rock salt type crystal structure.

### BACKGROUND

A cathode is a key component of a battery or fuel cell. Particularly, the cathode serves as a positive electrode where cations migrating from an anode and through an electrolyte electrochemically react with electrons arriving at the cathode via an external circuit. In addition, discovery and/or development of new materials from which cathodes are formed (i.e., cathode materials) can be desirable. However, the development of such cathode materials can be time and cost intensive.

The present disclosure addresses issues related to new cathode materials, the development and/or discovery of new cathode materials, and other issues related to cathode materials.

### SUMMARY

This section provides a general summary of the disclosure and is not a comprehensive disclosure of its full scope or all of its features.

In one form of the present disclosure, a cathode for a battery includes a cathode material with the chemical formula Li_{1+δ}FeₓCr_{y}O₂ where 0≤δ≤1, and δ+x+y=2.

In another form of the present disclosure, a cathode for a battery includes a cathode material with a disordered rock-salt crystal structure and the chemical formula Li_{1+δ}FeₓCr_{y}O₂ where 0≤δ≤1, and δ+x+y=2.

In still another form of the present disclosure, a solid-state method for forming a lithium, iron, chromium containing cathode material for a battery includes wet ball milling solid precursors of lithium, iron, and chromium and forming a slurry, drying the slurry and forming a powder, sintering the powder, and dry ball milling the powder and forming a cathode material with a disordered rock-salt crystal structure and the chemical formula Li_{1+δ}FeₓCr_{y}O₂ where 0≤δ≤1, and δ+x+y=2.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 shows a Lithium-ion battery cell;

FIG. 2 shows a flow chart for a method of developing a cathode material according to one form of the present disclosure;

FIG. 3 shows four different crystal structures used in the development of cathode materials according to the teachings of the present disclosure;

FIG. 4 shows a graphical plot of x-ray diffraction for the LiFe_{0.25}Cr_{0.75}O₂ and Li_{1.2}Fe_{0.2}Cr_{0.6}O₂ powders, before and after dry ball milling, according to the teachings of the present disclosure;

FIG. 5A shows a graphical plot of 1, 2, 5, and 10 cycle charge/discharge plots for a CR-2032 coin cell with LiFe_{0.25}Cr_{0.75}O₂ powder, before dry ball milling (layered crystal structure);

FIG. 5B shows a graphical plot of 1, 2, 5, and 10 cycle charge/discharge plots for a CR-2032 coin cell with LiFe_{0.25}Cr_{0.75}O₂ powder, after dry ball milling (DRX crystal structure);

FIG. 5C shows a graphical plot of 1, 2, 5, and 10 cycle charge/discharge plots for a CR-2032 coin cell with Li_{1.2}Fe_{0.2}CVr_{0.6}O₂ powder, before dry ball milling (layered crystal structure);

FIG. 5D shows a graphical plot of 1, 2, 5, and 10 cycle charge/discharge plots for a CR-2032 coin cell with Li_{1.2}Fe_{0.2}CVr_{0.6}O₂ powder, after dry ball milling (DRX crystal structure);

FIG. 6A shows a graphical plot of capacity versus charge/discharge cycle number for the CR-2032 coin cells with the LiFe_{0.25}Cr_{0.75}O₂ powders before ball milling (layered crystal structure) and after ball milling (DRX crystal structure); and

FIG. 6B shows a graphical plot of capacity versus charge/discharge cycle number for the CR-2032 coin cells with the Li_{1.2}Fe_{0.2}CVr_{0.6}O₂ powders before ball milling (layered crystal structure) and after ball milling (DRX crystal structure).

### DETAILED DESCRIPTION

The present disclosure provides new cathode materials with a disordered-rock-salt (DRX) crystal structure (referred to hereafter as “DRX cathode material” or “DRX cathode materials”). In some variations, the DRX cathode materials have reduced volume change during charging and discharging of the secondary battery. And in at least one variation, the DRX cathode materials do not include relatively costly elements such as cobalt and exhibit enhanced ion diffusion and thereby provide for reduced charging times for secondary batteries. As used herein, the phrase “disordered-rock-salt crystal structure” refers to a crystal structure with the Fm-3m symmetry group, made up of alternating layers of oxygen and cations (which may be transition metals or lithium), where the transition metals and lithium atoms may occupy any site on the cation sublattice in any pattern—this is in contrast with ordered phases, where a distinct pattern is observed of no mixing between the lithium and transition metals (in other words, cation layers are either all-Li or all-TM). The present disclosure also provides methods synthesizing new cathode materials. for discovering cathode materials with the DRX crystal structure.

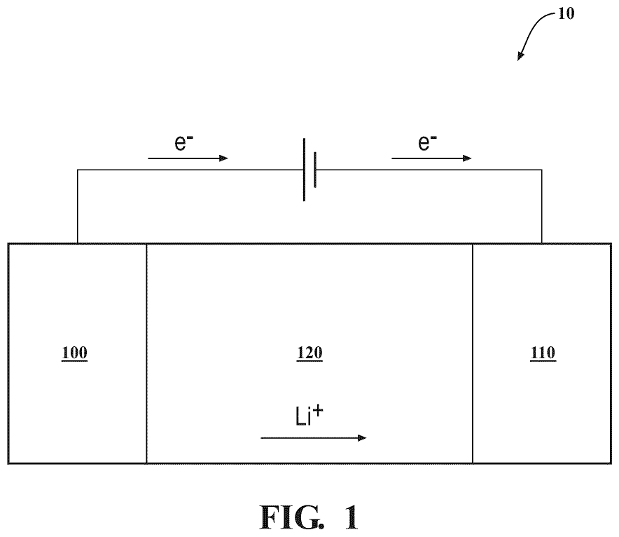

Referring to FIG. 1, a lithium (Li) ion battery 10 with an anode 100, a cathode 110, and an electrolyte 120 is shown. In some variations, the cathode 110 is formed from a DRX or DRX/layered cathode material having the chemical formula Li_{1+δ}MₓM′_{y}O₂ where M and M′ are one or more elements selected from magnesium (Mg), aluminum (Al), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), germanium (Ge), yttrium (Y), zirconium (Zr), niobium (Nb), molybdenum (Mo), ruthenium (Ru), rhodium (Rh), palladium (Pd), cadmium (Cd), indium (In), tin (Sn), antimony (Sb), hafnium (Hf), tantalum (Ta), tungsten (W), iridium (Ir), lead (Pb), and bismuth (Bi). In some variations, 0≤δ≤1, while in other variations 0<δ≤1. In at least one variation, 0≤δ<1, and in some variations 0<δ<1. Also, the coefficients x and y are integers or non-integers (+/−0.05) such that δ+x+y=2. Also the phrase “integers (+/−0.05)” refers to a range of values between −0.05 and +0.05 of a given δ, x, and/or y value. For example, for the chemical formula Li_{1+δ}FeCrO₂ refers to compositions between Li_{1+δ}Fe_{0.95}Cr_{1.05}O₂ and Li_{1+δ}Fe_{1.05}Cr_{0.95}O₂, inclusive.

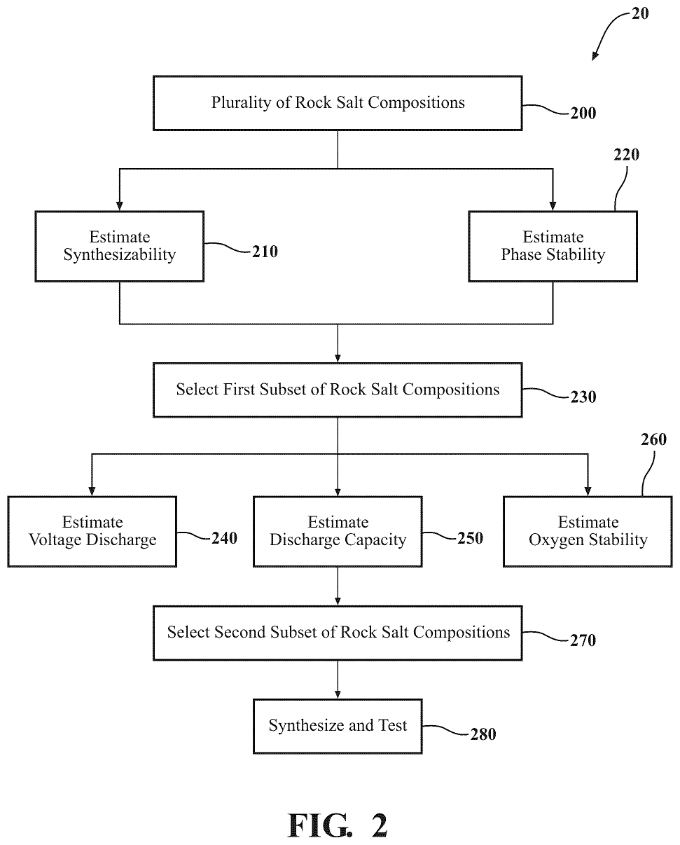

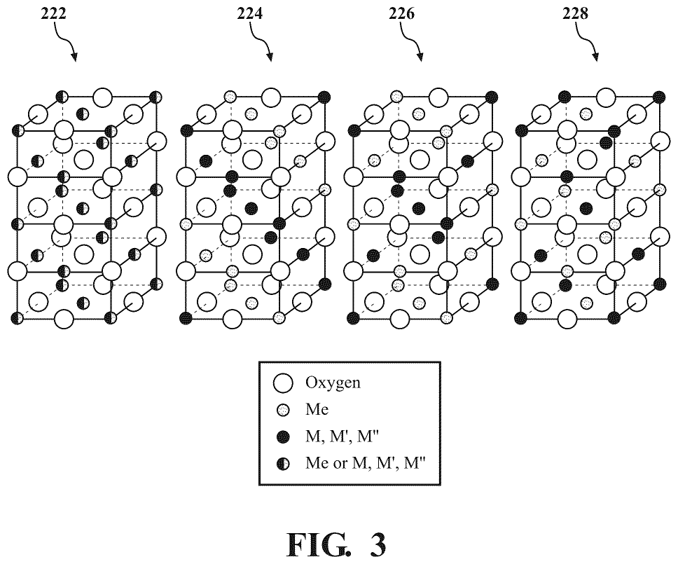

Referring to FIG. 2, a method 20 of discovering DRX cathode materials includes selecting, providing, and/or generating a plurality of cathode material compositions having a rock salt type crystal structure at 200, estimating a synthesizability for each of the cathode material compositions at 210, and estimating the metal-ion diffusion for each of the cathode material compositions at 220. As used herein, the term “synthesizability” refers to the thermodynamic stability of a predefined phase (i.e., crystal structure) at a predefined temperature (e.g., 1000° C.) for a given cathode material composition. In some variations, estimating the synthesizability for each of the cathode material compositions at 210 includes estimating the phase stability of a DRX crystal structure 222 and one or more of a layered crystal structure 224, a spinel-like crystal structure 226, and a γ-LiFeO₂-like crystal structure 228 illustrated in FIG. 3 and described in greater detail in the reference Alexander Urban, Jinhyuk Lee, Gerbrand Ceder, “The Configurational Space of Rocksalt-Type Oxides for High-Capacity Lithium Batteries”, Advanced Energy Materials, Vol. 4, Issue 13, Sep. 16, 2014. As used herein, the phrase “layered crystal structure” refers to a crystal structure in which atoms are chemically bonded in plane layers of the crystal structure in the R-3m space group in sets of four alternating layers in the pattern of oxygen, transition metals, oxygen, and lithium. And in some variations, the cathode material compositions generated at 200 have the formula Li_{1+δ}FeₓCr_{y}O₂.

In some variations the available oxidation states of cations and/or octahedral coordination preference of each cation in oxides are/is determined for each of the cathode material compositions. And in at least one variation, the generation of the cathode material compositions at 200 includes each of the cathode material compositions being charge balanced and having a cation redox capability of extracting at least 0.5 Li per formula unit.

In some variations, estimating the synthesizability at 210 includes designing a Special Quasirandom Structure (SQS) as a representative supercell for each of the DRX crystal structure 222, the layered crystal structure 224, the spinel-like crystal structure 226, and the γ-LiFeO₂-like crystal structure 228 (collectively referred to herein as “crystal structures 222-228), and predicting the mixing enthalpy of disordering for each cathode material composition—crystal structure combination. In at least one variation, the SQSs are designed as taught in the reference Phys. Rev. Lett. 1990, 65, 353, by A. Zunger et al., which is incorporated herein in its entirety by reference.

Not being limited by theory, a SQS is a limited-size low-symmetry periodic supercell chosen to have cluster correlations close to their random limit, and a SQS can be used to effectively predict the mixing enthalpy and order-disorder transition temperature of a DRX. In some variations, shorter (smaller) clusters of atoms are assumed to provide enhanced prediction characteristics or estimates, and in such variations an objective function to be minimized can take the form:

$$Q = - ω L + {\sum }_{α} \vert {Γ}_{α}^{SQS} - {Γ}_{α}^{rnd} \vert \qquad ( 1 )$$

where ω is a customizable weight parameter and L is the maximum cluster length such that all correlations Γ_{α} for clusters a with diameter less than L in an SQS agree with the targeted random distribution.

In some variations, 64-atom SQSs for the crystal structures 222-228 are generated and four 128-atom SQSs for the crystal structures 222-228 are also generated to evaluate size convergence. In at least one variation, the SQSs for the DRX crystal structure of each of the cathode material compositions are generated with the element ratio of Li(M_{0.5} M′_{0.5})O₂ and all cations are allowed to randomly mix on all cation sites. And the SQSs for the layered, spinel-like, and γ-LiFeO₂-like crystal structures are designed with same the Li_{0.5}M′_{0.5} ratio, but with Li on its own sublattice and the M, and M′ cations placed and mixed on the remaining cation sites as random as possible.

For example, in some variations, the mixing enthalpy of disordering is calculated for each cathode material composition represented by the SQSs for the crystal structures 222-228 using first principles energy calculations (e.g., Density Functional Theory (DFT) calculations), and Long Range Order (LRO) and Short Range Order (SRO) crystal structure preferences are estimated for each cation combination (i.e., each crystal structure for each cathode material composition) based on the first pinciples energy calculations. In at least one variation, DFT energies for the SQSs are transformed to convex hull energies (Eₕᵤₗₗ) generated with the Open Quantum Materials Database (OQMD) as taught in the reference npj Comput Mater 2015, 1, 1, by S. Kirklin et al., and the reference JOM 2013, 65, 1501, by J. E. Saal et al., both of which are incorporated herein in their entirety by reference.

In some variations, high-throughput DFT (HT-DFT) energy calculations are executed using the OQMD framework with coarse ionic relaxations first performed with OQMD default DFT settings. In such variations, the HT-DFT energy calculations are converged to 10⁻³ eV for ionic relaxation loop and 10⁻⁴ eV for electronic SC-loop, followed by static calculations with 520 eV cutoff energy for plane wave basis set and 8,000 k-points per reciprocal atom (KPPRA). Fine ionic relaxations are then performed for top candidates to check force convergence with a 520 eV cutoff energy and 8000 KPPRA converged to 10⁻² eV A⁻¹ for ionic relaxation loop, followed by final static calculations converged to 10⁻⁶ eV to get energies transformed to Eₕᵤₗₗ.

In some variations, the Eₕᵤₗₗ energies are compared with TS_{config} where T=1273 K and S_{config} is the ideal configuration entropy from the mixing sites and final Eₕᵤₗₗ−TS_{config} free energies are used for predicting LRO tendency for each composition. And in at least one variation, the SRO for each of the four SQS representative supercells is assumed to be the same as the LRO.

In some variations, estimating the metal-ion diffusion at 220, a SQS is designed as a representative short-range order (SRO) cell each of the DRX crystal structure 222, the layered crystal structure 224, the spinel-like crystal structure 226, and the γ-LiFeO₂-like crystal structure 228. Not being bound by theory, and for example, for rock salt-type LiMO₂, a relevant SRO to Li diffusion is from the smallest 4-body cluster of the Oₕ site. Stated differently, the population and connectivity of the Li₄ (0-TM) cluster are the significant factors for the SQS. In some variations, the sensitivity of the preference of each composition for an Li₄ or Li-M mixing configuration is considered for a screening strategy.

In some variations, the SQS for the LRO spinel-like crystal structure and the SQS for the LRO γ-LiFeO₂-like crystal structure were used as a first approximation of the SQS for the SRO spinel-like crystal structure and the SQS for the SRO γ-LiFeO₂-like crystal structure, respectively. However, it should be understood that the SRO parameter(s) for DRX crystal structures is a function of a local chemical ordering effect and the LRO parameter for DRX crystal structures should equal zero, i.e., there is no well-defined ordering on the metal-ion sublattice. Accordingly, the SQS for a metal-ion ordered sublattice is not the actual or theoretically accurate representation of disorder materials with specific SRO, but SRO and LRO have been found to be same type and has been used to explain the SRO tendency in DRX crystal structures. Accordingly, the SQS for the LRO spinel-like crystal structure and the SQS for the LRO γ-LiFeO₂-like crystal structure were used for qualitative estimates of the SRO energetics for the plurality of cathode material compositions and the SRO descriptor was designed to be the Eₕᵤₗₗ difference between the spinel-like crystal structure and the γ-LiFeO₂-like crystal structure.

The method 20 selects a first subset of cathode material compositions from the cathode material compositions at 230 based on the estimated synthesizability and/or the metal-ion diffusion of each of the cathode material compositions executed or performed at 210, 220, respectively. Stated differently, the cathode material compositions that exhibit a tendency of being synthesized and stable in a desired phase are selected as the first subset of cathode material compositions for continued study. For example, in some variations the first subset of cathode material compositions is selected from the cathode material compositions exhibiting a tendency of being synthesized and having the DRX crystal structure 222 and/or the layered crystal structure 224. As used herein, the phrase “tendency” refers to a qualitative and/or quantitative measurement or calculation for a desirable result using known chemical and/or physical properties. For example, in some variations a tendency of being synthesized refers to a quantitative calculation and/or formation energy calculated value for a cathode material composition having the DRX crystal structure 222.

The method 20 estimates a voltage discharge for each of the first subset of cathode material compositions at 240, a discharge capacity for each of the first subset of cathode material compositions at 250, and an oxygen stability for each of the first subset of cathode material compositions at 260. In some variations, the voltage discharge is estimated with metal-ion chemical potentials of ground states by Grand Canonical Linear Programing (GCLP) and the discharge capacity is estimated from the cation redox contribution.

For example, in some variations, the grand canonical free energy Ω(μ_{Li}) at each Li chemical potential μ_{Li}; is assumed to be directly related to the voltage and has the form:

$$Ω ( {μ}_{Li} ) = {\sum }_{j} {x}_{j} {F}_{j} - {μ}_{Li} {\sum }_{j} {x}_{j} {n}_{j}^{Li} \qquad ( 2 )$$

where xⱼ is the molar fraction of phase j with corresponding free energy Fⱼ and Li amounts per formula unit of nⱼ^{Li}. Also, Ω(μ_{Li}) is then the objective function of the linear programming problem with respect to variables x while holding the conservation constraint on other species.

The method 20 selects a second subset of cathode material compositions from the first subset of cathode material compositions based on the voltage discharge, discharge capacity, and/or oxygen stability at 270. In some variations, the method 20 includes synthesizing and evaluating (testing) on at least a portion of the second subset or cathode material compositions at 280. Stated differently, the first subset of cathode material compositions that exhibit a voltage discharge, discharge capacity, and/or oxygen stability above or below a predefined value are selected as the second subset of cathode material compositions for continued synthesizing and testing at 280.

Still referring to FIG. 2, in at least one example, approximately six thousand (6,000) possibly cathode material compositions were generated at 200, forty-four (44) cathode material compositions were selected as the first subset of cathode material compositions at 230, and one (1) cathode material composition (Li₂FeCrO₄) was selected as the second subset of cathode material compositions at 270.

The theoretical maximum cation capacity is computed by assuming a range of oxidation states that each transition metal can assume in the composition and that respectively during charge/discharge the transition metals are oxidized/reduced to their respective maximum/minimum oxidation states. From here, assuming a unit charge associated with each in units of milli-ampere hours, a gravimetric charge capacity may be estimated. The GCLP estimations are performed by comparing the energies obtained from first-principles simulation associated with each phase against a database of known phases, and computing the change in energy that would result from decomposition of the chemical compound in question to the most stable known forms of the constituent elements. This problem—solved using the formalism of linear programming—is performed at varying Li chemical potential, which allows an estimate of how this decomposition energy changes as a function of Li content of the composition. This change in energy as Li is inserted into the material (during intercalation) can be estimated by this process, and when interpreted as the change in energy of the cathode during lithiation and delithiation, can be used to estimate what the operating voltage of the cathode looks like. Taking the average of this voltage over a range of lithiation/delithiation gives the average voltage, and taking the max-min (voltage drop) gives an estimate of the voltage window. This procedure is detailed elsewhere in Akbarzadeh, Alireza R., Vidvuds Ozolins, and Christopher Wolverton “First-principles determination of multicomponent hydride phase diagrams: application to the Li—Mg—NH system.” Advanced Materials (Weinheim) 19 (2007).

Two compositions, one with a composition corresponding to LiFe_{0.25}Cr_{0.75}O₂ and one with a composition corresponding Li_{1.2}Fe_{0.2}Cr_{0.6}O₂, were prepared using solid-state synthesis, which entails combining/mixing powder precursors together before treatment at high temperature in a furnace. The powder precursors were Li₂CO₃ (Wako, 99.0%), Cr₂O₃ (Nacalai Tesque, 98.5%), and Fe₂O₃ (Kojundo chemical laboratory, 99.9%). The appropriate powder precursors (raw materials) were mixed in stoichiometric composition quantities, except for Li₂CO₃, which was included with 3% excess. A mixture of 3 grams of raw materials and 6 milliliters of ethanol was placed in a 45 mL ball milling pot and wet ball milled at 300 rpm for 255 minutes to form a slurry using a Pulversettle 7 (FRITSCH) ball mill. The slurry was dried at 120° C. under vacuum to form a dry powder and the dry powder was placed in a boat-shaped crucible with copper foil wrapped around it and sintered at 1000° C. in a furnace for 12h in an argon (Ar) or air atmosphere to form a sintered sample. The sintered sample was then taken out of the furnace at 120° C. and quickly transferred to an Ar atmosphere glove box to minimize air exposure. Inside the glove box, the sintered sample was ground with an agate mortar to form a sintered powder and fine DRX particles were formed (when present) by placing 1 gram of the sintered powder into a ball milling pot in an Ar-glove box and balled milling at 600 rpm for 30 hours using the Pulversettle 7 ball mill. In addition, crystal structures of the powders were measured using an X-ray diffractometer (XRD) with Cu-Kα radiation in the range of 5-120° with a 0.005° step and a 2° min⁻¹ scan speed.

For electrochemical evaluation, the LiFe_{0.25}Cr_{0.75}O₂ and Li_{1.2}Fe_{0.2}Cr_{0.6}O₂ powders, before and after dry ball milling, were evaluated in or using CR-2032 coin cells. Particularly, active material/acetylene black/PVdF(KFL #1120) with a weight ratio of 75/13.2/11.8 were dispersed and mixed in N-methyl-2-pyrrolidone to form a slurry. Next, the slurry was coated on an aluminum current collector foil and vacuum dried at 120° C. overnight to produce a positive electrode sheet. Also, 1M LiPF₆ in EC/DMC/EMC (30/30/40 vol. %) was used as an electrolyte, and metal Li foil was used as a negative electrode. And evaluation of a given CR-2032 coin cell was performed at 25° C. in a voltage range of 1.5-4.8V and a 0.1C rate.

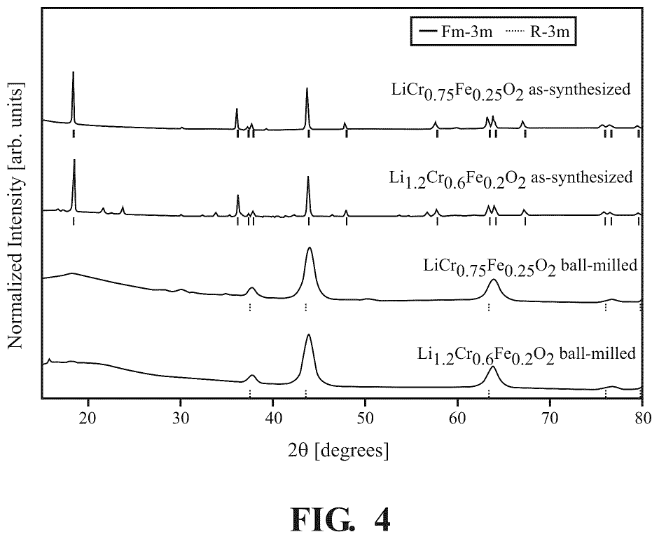

Referring to FIG. 4, plots of x-ray diffraction of the LiFe_{0.25}Cr_{0.75}O₂ and Li_{1.2}Fe_{0.2}Cr_{0.6}O₂ powders, before and after dry ball milling, are shown. And as observed from FIG. 4, the Fm-3m symmetry group was present for the dry ball milled powders, but was not present for the powders that were not dry ball milled. Stated differently, the LiFe_{0.25}Cr_{0.75}O₂ and Li_{1.2}Fe_{0.2}Cr_{0.6}O₂ powders subjected to dry ball milling exhibited or had a DRX crystal structure, whereas the LiFe_{0.25}Cr_{0.75}O₂ and Li_{1.2}Fe_{0.2}Cr_{0.6}O₂ powders not subjected to dry ball milling exhibited or had a layered crystal structure.

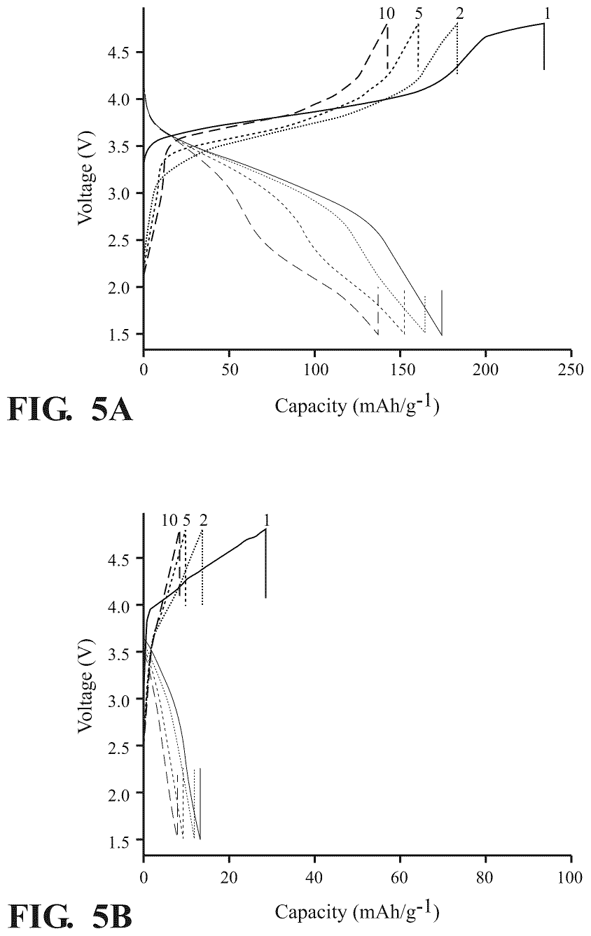

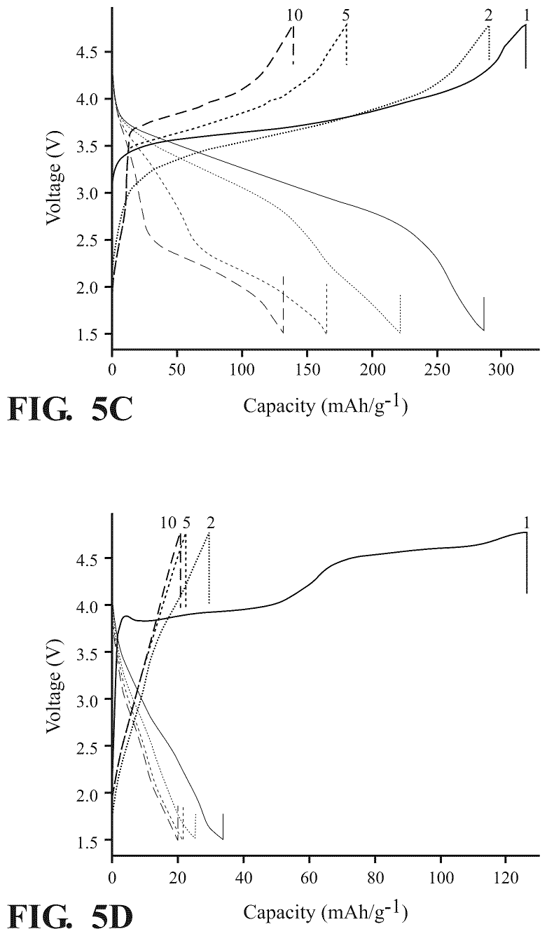

Referring to FIGS. 5A-5D, electrochemical evaluation results for the CR-2023 coin cells are shown. Particularly, 1, 2, 5, and 10 cycle charge/discharge plots for the LiFe_{0.25}Cr_{0.75}O₂ and Li_{1.2}Fe_{0.2}CVr_{0.6}O₂ powders, before and after dry ball milling, are shown with FIG. 5A illustrating the results of the CR-2032 coin cell with the LiFe_{0.25}Cr_{0.75}O₂ powder before dry ball milling (layered crystal structure), FIG. 5B illustrating the results of the CR-2032 coin cell with the LiFe_{0.25}Cr_{0.75}O₂ powder after dry milling (DRX crystal structure), FIG. 5C illustrating the results of the CR-2032 coin cell with the Li_{1.2}Fe_{0.2}CVr_{0.6}O₂ powder before dry ball milling (layered crystal structure), and FIG. 5D illustrating the results of the CR-2032 coin cell with the Li_{1.2}Fe_{0.2}CVr_{0.6}O₂ powder after dry ball milling (DRX crystal structure). And as observed from FIGS. 5A-5D, the CR-2032 with the DRX LiFe_{0.25}Cr_{0.75}O₂ and Li_{1.2}Fe_{0.2}CVr_{0.6}O₂ powders, i.e., after dry ball milling, exhibited an increase in both charge and discharge capacity. In addition, the CR-2032 with the DRX LiFe_{0.25}Cr_{0.75}O₂ and Li_{1.2}Fe_{0.2}CVr_{0.6}O₂ powders exhibited less discharge capacity during cycling, thereby demonstrating the “DRX cathodes” performed better than the “layered cathodes.”

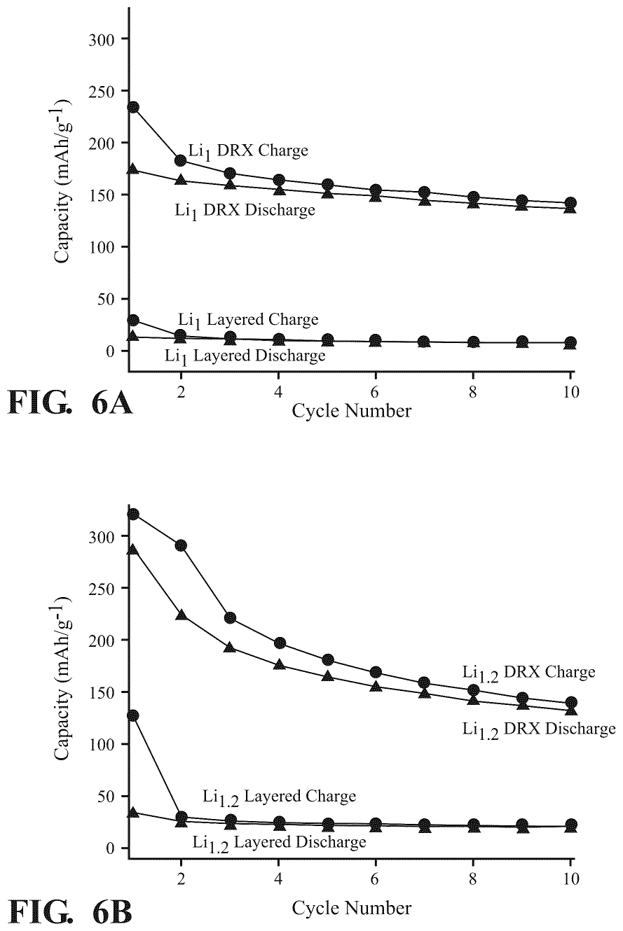

Referring to FIGS. 6A-6B, capacity versus charge/discharge cycle number is shown with FIG. 6A illustrating the results for the CR-2032 coin cells with the LiFe_{0.25}Cr_{0.75}O₂ powders, before (layered crystal structure) and after (DRX crystal structure) dry ball milling, and FIG. 6B illustrating the results for the CR-2032 coin cells with the Li_{1.2}Fe_{0.2}CVr_{0.6}O₂ powders, before (layered crystal structure) and after (DRX crystal structure) dry ball milling. And as observed form FIGS. 6A-6B, the CR-2032 with the LiFe_{0.25}Cr_{0.75}O₂ and Li_{1.2}Fe_{0.2}CVr_{0.6}O₂ powders, after dry ball milling, exhibited an increase in both charge and discharge capacity, as well as capacity retention during cycling, thereby demonstrating the “DRX cathode” performed better than the “layered cathode.”

While described as methods and illustrated with flowcharts, it should be understood that the present disclosure provides for systems that execute the methods described herein. For example, a system disclosed herein can include a processor, a memory communicably coupled to the processor and storing machine-readable instructions that, when executed by the processor, cause the processor to perform the methods and/or method steps disclosed herein, among others.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. Atypical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++, Python, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should also be understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A cathode for a battery, the cathode comprising:
a cathode material with the chemical formula Li_{1+δ}FeₓCr_{y}O₂ where 0≤δ≤1, and δ+x+y=2.

2. The cathode according to claim 1, wherein the cathode material comprises a disordered rock-salt crystal structure.

3. The cathode according to claim 2, wherein 0≤δ≤0.5, x≤0.5, and y>0.5.

4. The cathode according to claim 3, wherein 0≤δ≤0.4, x≤0.4, and y>0.5.

5. The cathode according to claim 4, wherein 0≤δ≤0.3, x≤0.3, and y>0.5.

6. The cathode according to claim 5, wherein 0≤δ≤0.3, x≤0.25, and y>0.5.

7. The cathode according to claim 1, wherein the cathode material is LiFe_{0.25}Cr_{0.75}O₂.

8. The cathode according to claim 1, wherein the cathode material is Li_{1.2} Fe_{0.2}Cr_{0.6}O₂.

9. The cathode according to claim 1, wherein the cathode material is selected from the group consisting of LiFe_{0.25}Cr_{0.75}O₂ and Li_{1.2} Fe_{0.2}Cr_{0.6}O₂.

10. A cathode for a battery, the cathode comprising:
a cathode material with a disordered rock-salt crystal structure and the chemical formula Li_{1+δ}FeₓCr_{y}O₂ where 0≤δ≤1, and δ+x+y=2.

11. The cathode according to claim 10, wherein 0≤δ≤0.5, x≤0.5, and y>0.5.

12. The cathode according to claim 11, wherein 0≤δ≤0.4, x≤0.4, and y>0.5.

13. The cathode according to claim 12, wherein 0≤δ≤0.3, x≤0.3, and y>0.5.

14. The cathode according to claim 13, wherein 0≤δ≤0.3, x≤0.25, and y>0.5.

15. The cathode according to claim 10, wherein the cathode material is LiFe_{0.25}Cr_{0.75}O₂.

16. The cathode according to claim 10, wherein the cathode material is Li_{1.2} Fe_{0.2}Cr_{0.6}O₂.

17. The cathode according to claim 16, wherein the cathode material is selected from the group consisting of LiFe_{0.25}Cr_{0.75}O₂ and Li_{1.2} Fe_{0.2}Cr_{0.6}O₂.

18. A solid-state method for forming a lithium, iron, chromium containing cathode material for a battery, the solid-sate method comprising:
wet ball milling solid precursors of lithium, iron, and chromium and forming a slurry;
drying the slurry and forming a powder;
sintering the powder; and
dry ball milling the powder and forming a cathode material with a disordered rock-salt crystal structure and the chemical formula Li_{1+δ}FeₓCr_{y}O₂ where 0≤δ≤1, and δ+x+y=2.

19. The solid-sate method according to claim 18, wherein 0≤δ≤0.5, x≤0.5, and y>0.5.

20. The solid-sate method according to claim 18, wherein the cathode material is selected from the group consisting of LiFe_{0.25}Cr_{0.75}O₂ and Li_{1.2} Fe_{0.2}Cr_{0.6}O₂.
